(19) United States
(12) Patent Application Publication
(10) Pub. No.: US 2003/0163434 A1
(43) Pub. Date: Aug. 28, 2003

(54) Parking fee payment system

(76) Inventor: Steve Hjalmar Barends, Amsterdam (NL)

Correspondence Address: Steven M. Koehler, WESTMAN CHAMPLIN & KELLY, International Centre - Suite 1600, 900 South Second Avenue, Minneapolis, MN, 55402-3319, US

(21) Appl. No.: 10/342,105

(22) Filed: Jan. 14, 2003

Related U.S. Application Data
(63) Continuation-in-part of application No. 09/485,503, filed on Feb. 10, 2000, now abandoned.

(51) Int. Cl. G07B 15/02

(52) U.S. Cl. 705/418

(57) ABSTRACT

The invention relates to a parking fee payment system for the payment per unit time of the parking tariffs which are due for a vehicle in a particular area, the system comprising input means for inputting tariff data, verification means to enable verification by a parking attendant, means for exchanging data concerning a credit balance on a balance card, and means for debiting said credit balance in accordance with a specified tariff, wherein said system has been divided into a meter device, which can be mounted in the vehicle, and a charging device, which is portable.

### CROSS-REFERENCE TO RELATED APPLICATION

The present application is a continuation-in-part of and claims priority of U.S. patent application Ser. No. 09/485,503, filed Feb. 10, 2000, the content of which is hereby incorporated by reference in its entirety.

### BACKGROUND OF THE INVENTION

The present invention relates to a parking fee payment system for the payment per unit time of the parking tariffs which are due for a vehicle in a particular area, the system comprising input means for inputting tariff data, verification means to enable verification by a parking attendant, means for exchanging data concerning a credit balance on a balance card, and means for debiting said credit balance in accordance with a specified tariff. It should be noted that use of the word “means” throughout the description herein pertains to well known analog and/or digital circuitry, i.e. hardware and/or software to perform the function described.

A device of this kind is known as the so-called Piaf meter from French company Innovatron Systèmes Urbaines (ISU). Said Piaf meter comprises all the above means in one housing, which must be present in the vehicle, balance card included, during operation, that is, during the time that the credit balance is debited in accordance with a specified tariff. The Piaf meter must thereby be mounted in a manner which enables the parking attendant to check the verification data which are displayed on a screen on the Piaf meter. To that end, the Piaf meter may be suspended from the rear-view mirror, for example, or be placed on the dashboard behind the windscreen. Since the Piaf meter and the balance card present therein represents a certain value, and since its presence in the vehicle is apparent, there is a chance of someone breaking into the vehicle in order to steal the Piaf meter and the balance card (and any other valuables that may be present in the vehicle). Insurance companies will claim that the visible presence of valuables in the vehicle has provoked the theft, and they will refuse to compensate the loss.

### SUMMARY OF THE INVENTION

The object of the invention is to provide a parking fee payment system of the kind referred to in the introduction, wherein either the value of the part of the system that is present in the vehicle is so low that it cannot be said to provoke theft, or the part of the system that is present in the car is useless and therefore not interesting for thieves.

According to the invention, this objective is accomplished in that the system comprises a meter device which can be mounted inside the vehicle, and a charging device, which is portable.

This division of the parking fee payment system into two parts makes it, for example, possible for the charging device, which can be taken along by the user, to comprise the most valuable parts of the parking fee payment system, in particular inclusive of the balance card, so that the meter device, which remains behind in the vehicle, will provoke theft to the least possible degree. Another way to prevent theft is to adapt the particular meter and charging devices such that they can only operate together in a pair, thus making the meter device useless without the corresponding charging device.

In one embodiment of the invention, said input means for inputting tariff data and said means for exchanging data relating to a credit balance on a balance card are accommodated in the charging device. As a result of this, the balance card need not remain behind in the vehicle.

In another embodiment of the invention, the charging device furthermore comprises said debiting means as well. If the maximum parking time determined by the credit balance on the balance card is exceeded, the user can simply exchange the empty balance card for a new balance card at the location where he is present at that moment, without having to return to the parked vehicle.

According to another embodiment, the invention provides identification means, with which the part of the system that is to be left behind in the vehicle, for example the meter device, may be equipped, and which contain vehicle data, for example, so that it will be useless to steal the system from the vehicle.

To that end the meter device may be provided with a permanent, non-erasable identification, which can be verified by the parking attendant, and which renders the meter device worthless when it is removed from the vehicle. Said identification may identify the user, but also, for example, the chassis number, the registration number, the type, the color, the issuing authority and/or the producer. If the meter device is provided with such a code, it may be called an encoding device.

The identification may be very small. It may transmit permanent or intermittent signals, for example, which can be verified by a competent authority, a parking attendant, for example. Said signals may be infrared, ultrasonic or electromagnetic signals, for example. Furthermore it is possible to attach the identification in such a manner that it cannot be removed or damaged. This may be done by fixedly mounting the meter device comprising the identification in a vehicle, but also by fixing the identification separately in a vehicle. In these cases it is also possible to track down missing vehicles. This can be done by means of cellular techniques, for example, wherein a base station receives the signal from the meter device of the vehicle which has been reported missing. Subsequently, the exact location of the vehicle can be determined by means of more sophisticated equipment.

The identification may be provided not only in vehicles, but also on personal jewelry or articles such as watches, rings, medallions, spectacles, shoes, (portable) sound equipment, etc.

The charging device may furthermore comprise a verification circuit for securing the exchange of balance data with the balance card, which verification circuit functions to prevent unauthorized use of the balance card and the charging device by means of a Personal Identification Number (PIN).

According to another embodiment of the invention, the meter device, when operating (that is, when parking in an area where a parking fee is due), can only be controlled by the charging device by means of which the meter device has been set operating, whereby verification of the permanent identification or the personal identification takes place. The advantage of this arrangement is that, as mentioned before, the meter device which remains behind in the vehicle is entirely useless without the corresponding charging device, so that theft is provoked even less.

The verification of the parking data may take place by means of a known display screen, which is connected to the meter device. According to another preferred embodiment, however, the meter device furthermore comprises a transmission device to enable the transmission of verification data from the meter device to a reading device which is in the parking attendant's possession. According to another embodiment, the transmission device employs infrared, electromagnetic or ultrasonic transmission.

According to an extended embodiment, the system includes a data center controlled by a payment system management, the meter device comprising transmission means to enable communication between the meter device and the data center.

For example, the data center and the meter device are adapted to exchange at least one of the following data: a system identification on the meter device; an identification of the balance card that charged the meter device; time and date on which the debiting of a credit balance has started; a parking tariff and/or set time period.

The invention also includes a method of paying a parking fee, preferably using the system specified above, and including starting the meter device, causing the meter device to communicate with the data center and exchanging data between the meter device and the data center, including identification information of the meter device, and information about the time when the debiting is started, stopping the meter device, causing the meter device to communicate with the data center and exchanging data between the meter device and the data center, including identification information of the meter device and information about the time when the debiting is stopped.

The preferred embodiments of the invention will be discussed hereafter with reference to the figures.

### BRIEF DESCRIPTION OF THE DRAWINGS

FIG. 1 is a block diagram of an embodiment of the invention.

FIG. 2 is a block diagram of another embodiment of the invention.

FIG. 3 is a block diagram of a further embodiment of the invention, wherein the verification means are shown in more detail.

FIG. 4 is a block diagram of an extended embodiment of the parking fee payment system according to the invention.

### DETAILED DESCRIPTION OF THE ILLUSTRATIVE EMBODIMENTS

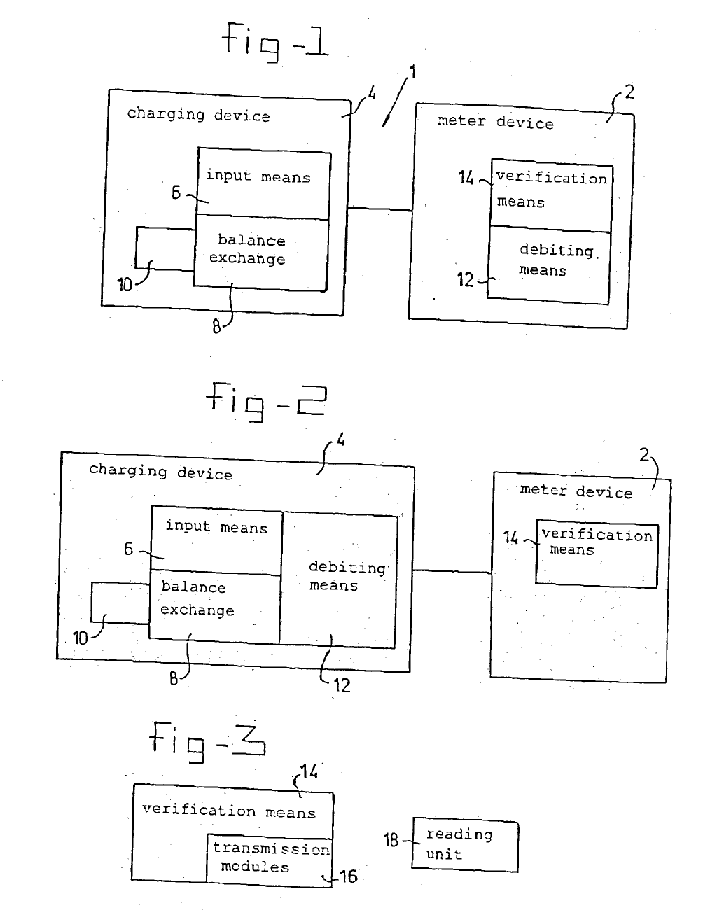

FIG. 1 shows the parking fee payment system comprising a meter device 2 and a charging device 4. The parking fee payment system is intended for paying parking fees which are due in dependence on a specific parking tariff per unit time for the area in question.

Meter device 2 must be provided in the vehicle which is parked is a specific area where parking fees are due. The meter device 2 has thereby been mounted in the vehicle in such a manner that it will not provoke theft. The charging device 4 is a device which the user must carry with him, and which can be detachably connected to the meter device 2.

Charging device 4 comprises input means 6, which are used for inputting data relating to the desired tariff, which corresponds with the tariff which is applicable for the area where the vehicle is parked, and to the balance to be transferred from balance card 10. Said input means 6 may for example consist of a keyboard comprising a display screen for checking the input data. The input data are transmitted to the debiting means 12 to be discussed hereafter.

Charging device 4 furthermore comprises means 8 for exchanging data relating to a credit balance on a balance card 10. Balance card 10 is a known card, which can be obtained against payment of a specified amount from a designated authority, on which card the balance has been electronically recorded. The balance card 10 may for example be a known card comprising a magnetic strip, or a card comprising a semiconductor circuit, in which the balance data are recorded (“smart card”). The user inserts the balance card 10 into the charging device 4, and inputs the amount to be transferred from balance card 10 to the means 8 for balance exchange by means of input means 6. The authority which issues the balance cards and which carries out the verification can determine whether the user can indicate a particular desired balance, or whether a fixed balance is to be transferred each time. The authority can also determine whether the balance present on the balance card is also the maximum balance which can be transferred, or whether a higher limit or no limit at all will be set as regards the balance to be transferred. In the latter case, the user must transfer the balance to the means 8 for balance exchange afterwards. In that case it is advisable to program the parking fee payment system so that a next parking period cannot commence before the preceding period has been paid for. After the parking period has elapsed, a positive balance that may be present can be reversed to balance card 10.

The data with regard to the parking tariff and the input credit balance are transmitted to the debiting means 12, which, according to one embodiment of the invention, are present in meter device 2. The debiting means debit the credit balance with the parking tariff per unit time for the area in question.

Data with regard to the input tariff zone (or the corresponding parking area), the time at which the parking was started and an indication that a credit balance remains and will be debited, are transmitted by the debiting unit to the verification means 14, which are present in meter device 2. In one preferred embodiment of the invention, said data are shown in such a manner that a parking attendant can verify them. This may take place, for example, by means of a display screen which is placed behind the windscreen of the vehicle.

Another preferred embodiment of the invention is shown in FIG. 2. In this embodiment, charging device 4 rather than meter device 2 comprises the debiting means 12. This makes it possible to realize a further reduction of the meter device 2, so that its value will be even lower, as a result of which it will provoke theft even less. Furthermore, the user can exchange a balance card 10 whose credit balance has been used up for a balance card 10 containing a credit balance at the location where the user is present at that point in time, and he does not need to return to the parked vehicle. In this embodiment, an indication of the maximum parking time that remains is given to the verification means 14, rather than an indication of the credit balance that remains and that will be debited.

FIG. 3 shows an elaboration of the verification means 14 which the meter device 2 comprises. In the simplest embodiment, the verification means 14 comprise a display screen (not shown), which displays the verification data, either integrally or sequentially. In another embodiment of the invention the verification means 14 comprise transmission means 16 and a reading device 18. In that aspect, reading device 18 has been physically separated from meter device 2, it is in the parking attendant's possession. The transmission means 16 transform the verification data and send it to the reading device 18. This may take place by means of transmission with infrared signals, for example, whereby the transmission means 16 comprise at least one infrared transmitter, and whereby the reading device 18 comprises at least one infrared receiver. Alternatively, the transmission can take place via electromagnetic or ultrasonic waves.

In another embodiment of the invention, the meter device 2 comprises a non-erasable identification, for example the registration number of the vehicle, the chassis number, the user, the issuing authority and/or the producer, whereby the identification can be verified by the parking attendant as part of the verification data.

In yet another embodiment of the invention, the charging device 4 furthermore comprises a verification circuit for preventing, by means of a Personal Identification Number (PIN), unauthorized use of the balance card 10 and the charging device 4.

According to one embodiment of the invention, the meter device 2, when operating (that is, when parking in an area where a parking fee is due), can only be controlled by the charging device 4 by means of which the meter device has been set operating. Both the non-erasable identification and the PIN code may be used to check this. This aspect renders the meter device 2 even more useless once it has been stolen.

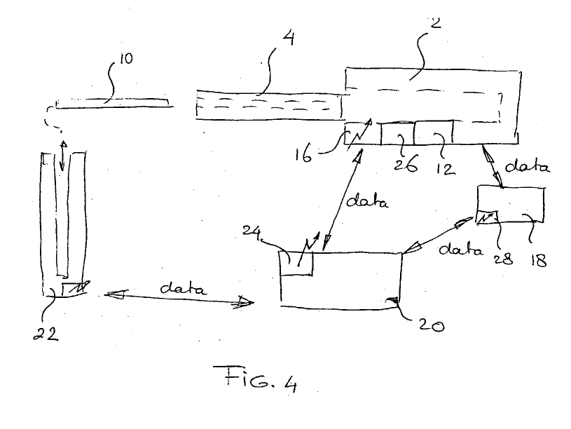

FIG. 4 illustrates an embodiment of an extended parking fee payment system. In this embodiment, the system includes not only the meter device 2, the charging device 4, the balance card 10 and the reading unit 18, but also a data center 20 and a revaluation device 22. The data center is controlled by the relevant parking fee payment management, and comprises a computer and transmission means 24 which is adapted to communicate with the transmission means 16 of the meter device 2. The communication can take place by any telecommunication technique such as SMS, GPRS, UMTS, wireless etc. and may be scrambled and secured. The meter device 2 has a chip 26 containing data. The transmission means 16, 24 of the data center 20 and the meter device 2 are adapted to exchange data to and from the chip 26 in the meter device 2. This data may include a meter device system identification, identification as to the balance card that has charged the meter device, time/data on which the debiting starts, parking tariff or parking periods, such as a half or full day. The meter device 2 comprises the debiting means 12 which is operably connected to the chip 26.

Every time a user stops the debiting action, in particular after parking, the transmission means of the meter device communicates with the data center and again transmits the above authentication/verification data together with data concerning the parking start and/or end time, and the data center stores the transaction history. In case the transmission upon start of the parking time was not successful, it is now possible to verify that the transaction has continued and the credit values in the meter device and in the data center can be synchronized as yet. For this purpose, the data center has a computer program to synchronize the transaction history and to set/reset credit values if necessary. Preferably, the data center debiting means is fully synchronized with the meter device debiting means. In case of a dispute, the credit history in the chip 26 of the meter device 2 may provide the decisive answer as to the balance value. The information on the meter device chip 26 is stored in a secured area thereof and may be transmitted to the data center 20.

The reading unit 18 of the parking attendant comprises transmission means 28 which is adapted to communicate both with the transmission means 16 in the meter device 2 and with the transmission means 24 in the data center. The reading unit 18 is adapted to check at least one of the following information: balance card identification; identification of the meter device and proper operation of debiting means therein, and activity of the debiting means; actual balance in the meter device; parking tariff; activity of the data center, and activity of any debiting means in the data center. Any transaction history that has not yet been transmitted, can be transmitted through the reading unit 16.

As mentioned above, the system also comprises a revaluation device 22 to revalue the balance card 10. Such revaluation device 22 may be a home revaluation device or a device that is present at a point of sales where the device is integrated in a network or distribution channel.

The home revaluation device 22 may be connected to a phone or modem in order to connect the device to the data center 20. Normally, the user will be asked to provide a PIN code at the start of the crediting procedure, after which a set amount will be debited from an account of the user and be credited to the data center. The transmission will be secured and scrambled by sufficiently long scrambling keys. The balance card 10 will then be credited with the specific balance value corresponding to the amount of money paid.

During this transmission, the data of the data center will be updated regarding balance card identification and authentication information, the new balance value, the date of the last crediting action, and the transaction and debiting history.

The revaluation at the points of sale may be similar as with the home device. Alternatively, the points of sale will credit the account at the data center with the value paid by the user at the point of sale. After this payment, the data center will credit the balance card correspondingly through the distribution channel or network and will also update the information mentioned above.

In this last embodiment, the meter device 2 and charging device 4 may be of the type of FIG. 1. The input means in the charging device 4 is not necessary in this embodiment, since the data center 20 will have the input means providing information regarding parking tariff etc. The meter device 2 and the charging device 4 are adapted such that the meter device 2 can only be credited by a balance card 10 through the corresponding charging device 4. Therefore, the meter device 2 is useless without the corresponding charging device 4.

It is a matter of course that a person skilled in the art will be able to derive other embodiments of the device from the above.

Although the present invention has been described with reference to preferred embodiments, workers skilled in the art will recognize that changes may be made in form and detail without departing from the spirit and scope of the invention.

What is claimed is:

1. A parking fee payment system for the payment per unit time of the parking tariffs which are due for a vehicle in a particular area, the system comprising:
input means for inputting tariff data;
verification means to enable verification by a parking attendant;
means for exchanging data concerning a credit balance on a balance card; and
means for debiting said credit balance in accordance with a specified tariff, wherein said system includes:
a meter device, which can be mounted in the vehicle; and
a charging device, which is portable.

2. The parking fee payment system according to claim 1, wherein said input means for inputting tariff data and said means for exchanging data relating to a credit balance on a balance card are accommodated in the charging device.

3. The parking fee payment system according to claim 2, wherein said meter device and said charging device are provided with means for transmitting the tariff data to the meter device.

4. The parking fee payment system according to claim 1, wherein said means for debiting the credit balance in accordance with an input tariff are accommodated in said charging device.

5. The parking fee payment system according to claim 1, wherein said meter device has been provided with a permanent identification.

6. The parking fee payment system according to claim 5, wherein said permanent identification comprises data relating to the vehicle.

7. The parking fee payment system according to claim 1, wherein said charging device furthermore comprises a circuit for verifying a personal identification before exchanging credit balance data with said balance card.

8. The parking fee payment system according to claim 6, wherein when the meter device is in operation, it can only be controlled by the charging device by means of which it has set operating, whereby verification of said permanent identification or said personal identification takes place.

9. The parking fee payment system according to claim 1, wherein said verification means, in order to enable verification by a parking attendant, comprise a transmission module present in said meter device and a portable reading unit.

10. The parking fee payment system according to claim 9, wherein said reading unit receives the verification data from said meter device via infrared, electromagnetic or ultrasonic transmission.

11. The parking fee payment system according to claim 1, wherein the system includes a data center controlled by a payment system management, the meter device comprises transmission means to enable communication between the meter device and the data center.

12. The parking fee payment system according to claim 11, wherein the data center and the meter device are adapted to exchange at least one of the following data:
a system identification on the meter device;
an identification of the balance card that charged the meter device;
time and date on which the debiting of a credit balance has started; and
a parking tariff and/or set time period.

13. The parking fee payment system according to claim 12, wherein the transmission means are adapted to transmit data in a secured and scrambled manner through a telecommunication technique.

14. A method of paying a parking fee by means of a parking fee payment system comprising:
a data center including first transmission means:
verification means to enable verification by a parking attendant;
means for exchanging data concerning a credit balance on a balance card; and
means for debiting said credit balance in accordance with a specified tariff, wherein said system includes:
a meter device which can be mounted in the vehicle and which includes second transmission means to communicate with the first transmission means of the data center;
a charging device which is portable and adapted to receive the balance card, comprising the steps of:
starting the meter device, causing the meter device to communicate with the data center and exchanging data between the meter device and the data center, including identification information of the meter device, and information about the time when the debiting is started; and
stopping the meter device, causing the meter device to communicate with the data center and exchanging data between the meter device and the data center, including identification information of the meter device and information about the time when the debiting is stopped.

15. The method of claim 14, wherein the data which is exchanged when the meter is started includes at least one of identification information of the balance card used for loading the meter device, the balance value in the meter device at the time the meter device is started and stopped, and parking tariff information.

16. The method of claim 14, including the step of verification of the meter device by a parking attendant by means of a reading unit, communicating with the meter device and the data center and checking at least one of the following information:
balance card identification;
identification of the meter device and proper operation of debiting means therein, and activity of the debiting means;
actual balance in the meter device;
parking tariff; and
activity of the data center, and activity of any debiting system in the data center.

17. The method of claim 14, including the step of crediting the balance card through a revalue device, said revalue device being operated to communicate with the data center by transmission means, by crediting the balance card and exchanging data including at least one of balance card identification and authentication, new balance value, date of last revaluation, history of transactions and debiting operations.
